(19) United States
(12) Patent Application Publication
(10) Pub. No.: US 2025/0100857 A1
(43) Pub. Date: Mar. 27, 2025

(54) Device for moving of a fork-type carrier, use and method

(71) Applicant: Kaup GmbH & Co. KG Gesellschaft für Maschinenbau, Aschaffenburg (DE)

(72) Inventor: Thomas GROSSER, Sulzbach am Main (DE)

(73) Assignee: Kaup GmbH & Co. KG Gesellschaft für Maschinenbau, Aschaffenburg (DE)

(21) Appl. No.: 18/833,800

(22) PCT Filed: Jan. 30, 2023
(86) PCT No.: PCT/DE2023/000007

§ 371 Date: Jul. 26, 2024

(30) Foreign Application Priority Data
Jan. 28, 2022 (DE) 10 2022 000 342.2

(51) Int. Cl. B66F 9/12; B66F 9/20

(52) U.S. Cl. CPC B66F 9/122; B66F 9/205

(57) ABSTRACT

A device for moving a fork carrier of a forklift includes an attachment unit arranged on a lifting mast with a scissor lever device having at least two oppositely rotatably mounted lever arm swings, which are rotatably contacted at at least one bearing point and which hold one fork carrier substantially normal to an axis of the lifting mast. The lever arm swings in a support region facing fork carrier and a support region facing the lifting vehicle have respectively at least one fixed support unit, and a support unit, which is displaceable when the scissor lever device is extended. At least one displaceable support unit, is slidable directly in contact with the lifting mast so that a direct force input into the lifting mast is established.

### CROSS-REFERENCE TO RELATED APPLICATION

This application is a national stage application, filed under 35 U.S.C. §371, of International Patent Application PCT/DE2023/000007, filed on Jan. 30, 2023, which claims the benefit of German Patent Application DE 10 2022 000 342.2, filed on Jan. 28, 2022.

### TECHNICAL FIELD

The present application relates to a device for moving a fork carrier of a forklift.

### BACKGROUND

It is known that forklifts with pantographs with attached fork carriers are used for transporting goods. However, there are often problems with the accuracy of the control of the forks, in particular also vibrations during driving.

### SUMMARY

The present application provides a reliable and flexible attachment device for a lifting vehicle.

The device for moving a fork carrier of a lifting vehicle with a lifting mast, in particular a forklift, comprises an attachment unit arranged on the lifting mast with a scissor lever device (pantograph swings) having at least two oppositely rotatably mounted lever arm swings, which are rotatably contacted at at least one bearing point and which hold a fork carrier movable substantially normally with respect to an axis of the lifting mast, wherein the lever arm swings in a support region facing the fork carrier and a support region facing the lifting vehicle each have at least one fixed support unit, in particular roller unit, and a support unit, in particular roller unit, which can be moved when the scissor lever device is extended, wherein at least one displaceable support unit, in particular roller unit, is arranged to be slidably supported in an integrated manner in the support region facing the lifting vehicle, directly in contact with the lifting mast, so that a direct force input into the lifting mast is established.

The device can advantageously be attached to a lifting mast of a lifting vehicle, on which a fork carrier is mounted in a height-adjustable manner, and can be adjusted normally to the lifting mast by means of the scissor lever device. By way of example, however, the device can also be attached to a specially movable lifting mast, a displaceable thrust mast, which likewise holds a fork carrier in a height-adjustable manner, and provide an additionally extended adjustability in the normal direction compared to the methods of a displaceable thrust mast. The invention provides a compact device which reliably enables flexible mobility without vibrations even in the case of rapid movements of the lifting vehicle, in particular a forklift. By means of the device, a reliable introduction of force of the load is delivered by the direct arrangement on the lifting mast. A separate force introduction is made possible by the integrated guide into the lifting mast in order to remove the internal support force of the device. In particular, a slide unit with rotatable roller units is immersed through openings in the slide unit and the internal force of the device is directed into a guide profile of the lifting mast. A corresponding interface is thus used to remove forces within the device in the sense of a force flow which is made possible for the support of the attachment device by direct entry of the supporting forces. movable roller unit advantageously in each case comprises a movable roller unit which is rotatable in itself, in particular additionally slidably in a guide direction, in particular guided in or on guide means, in particular rollable, in order to enable an optimal movement of the scissor lever device. In advantageous embodiments, the fixed support unit can be arranged vertically substantially above or also in further embodiments below the movable support unit, in particular roller unit. The fork carrier can be moved substantially normally, i.e. it is held substantially perpendicular to a lifting mast axis and can be guided, but can also be held, for example, at rising angles in order to enable a safe transport of applied goods or at descending angles during unloading of goods.

It is advantageous that the attachment unit at the support region facing the lifting vehicle of the scissor lever device has a carriage for moving the attachment unit along the lifting mast facing the lifting vehicle. The carriage means can advantageously achieve a large lifting height in a stable and secure manner, in particular the carriage means can be designed with different heights and displaceable support units, in particular roller units. By using the carriage means, an effective lifting height of the fork carrier can be better utilized compared to a lifting mast height.

It is advantageous that the carriage means for the traversing of the attachment unit along the lifting mast comprises at least one especially more guide rollers, in particular an upper guide roller and a lower guide roller, which enable the attachment unit to be moved along the lifting mast, wherein the fixed support unit, in particular roller unit, of the lever arm swing, that is fixed at the traversing of the scissor lever device, is connected to the carriage means and the displaceable support unit, in particular roller unit, facing the lifting vehicle, is designed to be slidable past the carriage means and/or through a feed-through through the carriage means directly on the lifting mast, especially scrollable.

The carriage means can be made wide and stable in a simple manner, since a load distribution takes place on the carriage and the lifting mast. Material and installation space are better integrated closely with the lifting mast, tilting of the carriage is reliably avoided, the widest possible support distance can be implemented on the lifting mast profile, in particular by an arrangement outside the lifting mast. The fork carriers with forks are held securely by a roller guide with roller integration.

The forces of the load as well as the natural weight of the attachment, in particular the tilting torque and the weight force, result in supporting forces which are introduced into the lifting mast of the forklift via roller units located outside the carriage. In advantageous embodiments, the fixed support unit can be arranged vertically substantially above or else in other arrangements below the movable support unit, in particular roller unit. Advantageously, a fixed support unit, in particular roller unit, of the lever arm swings is arranged above carriage roller units, in particular guide rollers of the carriage, whereby a higher lifting height is achieved.

Advantageously, a fixed support unit of the lever arm swings can be arranged below carriage roller units, in particular guide rollers of the carriage means. By means of the device, the load torques are reduced to the carriage means. This also results in lower resultant support forces which act on the lifting mast as well as the carriage roller units, in particular guide rollers of the carriage means. It also allows a lower retraction, for example diving below predetermined heights. The displaceable support unit, in particular roller unit, of the lever arm swing is advantageously guided through the passage of the carriage means, wherein the passage advantageously extends between the carriage roller units, in particular the carriage roller units are arranged at a distance which permits maximum freedom of movement of the lever arm swings and an optimized support function on the lifting mast.

The displacement movement of the lever arm swings, and thus a relative transversing of the displaceable support unit, in particular roller unit, in the elongated hole, will correspond in particular to a pallet to be received with the fork carrier.

It is advantageous, that the lifting mast has a cross-sectional shape in the sense of a C- and/or H-profile and that the displaceable support unit, in particular roller unit, is guided on legs of the C- and/or H-profile. A guide can advantageously be arranged in particular securely lying on the inside or lying on the outside with a larger support distance.

It is advantageous, that the guide rollers of the carriage means of the support region facing the lifting vehicle of the scissor lever device, in particular the upper guide roller and the lower guide roller, which enable a transversing of the attachment unit along the lifting mast, are guided on inner legs of the C and/or H profile of the lifting mast, and the movable support unit, in particular roller unit, is designed to slide past the carriage means and/or is designed to be slidable through a passage through the carriage means directly on the lifting mast, especially scrollable. The carriage can also be guided on the outside of the lifting mast, as a result of which an even larger and more stable support distance is possible.

It is advantageous, that the feed-through is formed in the form of an elongated hole, which enables a feed-through of the displaceable support unit, especially the roller unit, facing the lifting vehicle.

It is advantageous, that a height of the elongated hole is designed corresponding to at least a fraction of a total traversing of the lever arm swings of the scissor lever device, in particular approximately 50% of a total traversing of the lever arm swings, when the lever arm swings are designed with a bearing point.

It is advantageous, that a width of the carriage means is formed beyond a profile width of the C- and/or H-profile of the lifting mast, in particular in the region of the feed-through, in particular of an elongated hole.

The problem is solved by a use of a scissor lever device with at least two oppositely rotatably mounted lever arm swings, for holding a fork carrier essentially normal to a lifting mast of a lifting vehicle, wherein at least one displaceable support unit, in particular roller unit, is arranged in the support unit facing the lifting vehicle integrally supported directly on the lifting mast, so that a direct force input into the lifting mast is set up, in particular in contact with the lifting mast, especially scrollable, so that a direct force input into the lifting mast is set up.

The application also presents a method for using a device for moving a fork carrier of a lifting vehicle, with a lifting mast in particular of a forklift, in particular of a device as disclosed herein, wherein a device arranged on the lifting mast, with a scissor lever device having at least two lever arm swings, which are rotatably mounted in opposite directions, which are rotatably connected at at least one bearing point and by means of which a fork carrier is moved substantially normally to an axis of the lifting mast, wherein the lever arm swings in a at the support region facing the fork carrier and at the support region facing the lifting vehicle each have at least one fixed support unit, in particular roller unit, and a support unit which can be displaced when the scissor lever device is extended, in particular roller unit, for holding and/or transversing, wherein at least one displaceable support unit, in particular roller unit, in the support region which faces the forklift vehicle, slides, in particular rolls, in an integrated manner supported directly in contact with the lifting mast, so that a direct introduction of force into the lifting mast is effected.

### BRIEF DESCRIPTION OF THE DRAWINGS

FIG. 1 shows a device for moving a fork carrier of a lifting vehicle in side view.

FIG. 2a shows a device for moving a fork carrier of a lifting vehicle in side view.

FIG. 2b shows a device for moving a fork carrier of a lifting vehicle in plan view.

FIG. 3 shows a device for moving a fork carrier of a lifting vehicle in detail view.

FIG. 4 shows a device for moving a fork carrier of a lifting vehicle in side view.

### DETAILED DESCRIPTION

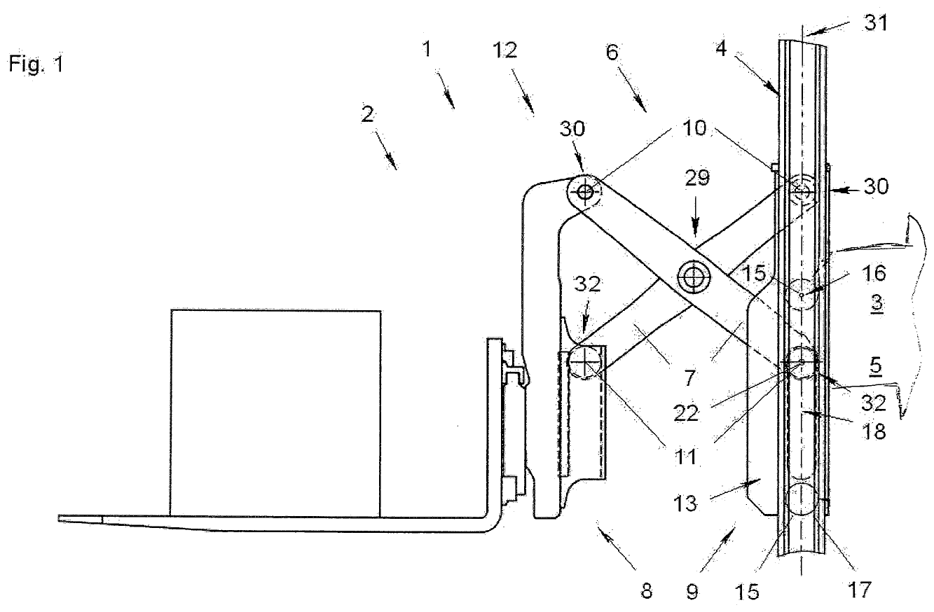

FIG. 1 shows a device 1 in side view for moving a fork carrier 2 of a lifting vehicle 3, with a lifting mast 4, in particular a movable thrust mast, in particular a forklift 5, comprising an attachment unit 12 arranged on the lifting mast 4, in particular thrust mast, with a scissor lifting device 6 in the sense of pantograph swings, with at least two rotatably mounted lever arm swings 7 which hold a fork carrier 2 substantially normal to the lifting mast 4, in particular thrust mast, wherein the lever arm swings 7 each have at least one support unit 32, in particular roller unit 10, which is fixed when the scissor lever device 6 is extended, and a support unit 32, in particular roller unit 11, which is displaceable when the scissor lever device 6 is extended, for mounting and/or experience, wherein at least one displaceable roller unit 11 is arranged in an integrated manner in the support region 9 facing the scissor lever device 4, in particular thrust mast, so that a direct force input into the lifting mast 4, in particular thrust mast, is set up, wherein the attachment unit 12 has a carriage 13 for transversing of the attachment unit 12 along the lifting mast 4, in particular thrust mast, on the support region 9 of the lifting vehicle facing the lifting vehicle 6 a carriage 13 for transversing of the attachment unit 12 along the lifting mast 4, in particular an upper guide roller 16 and a lower guide roller 17, which enable a transversing of the attachment unit 12 along the lifting mast 4, in particular thrust mast. The lever arm swings 7 advantageously always have at least one fixed support unit 30, in particular a roller unit 10, in the sense of a fixed holding point, corresponding to a bearing point, as well as at least two support units 32, in particular roller units 11, in the sense of guided displaceable bearing points, which, unlike the fixed support units, are free guided in one direction. Another support point 30, in particular roller unit 10, is determined as an exemplary fourth holding point in its position by the lengths of the lever arm swings 7, i.e. the kinematics. It can be moved with the scissor lever device 6. It can advantageously also be more than one support unit 30, 32 in each case.

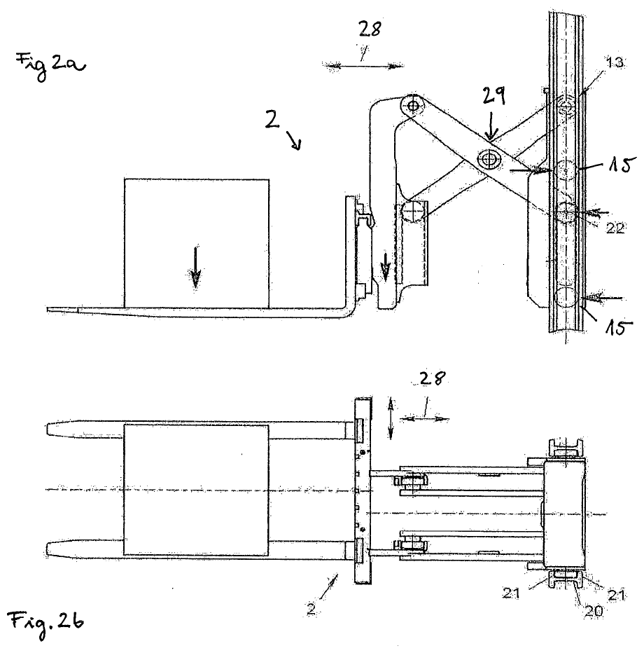

FIG. 2a shows a side view of the device 1 with an exemplary load distribution on the fork carrier 2, which is introduced into the lifting mast via a holding force.

FIG. 2b shows a plan view of the device 1, wherein the roller unit 10 of the lever arm rocker 7, which is fixed when the scissor lever device 6 is extended, is connected to the carriage means 13 and the displaceable roller unit 22 facing the lifting vehicle is designed to be rolled directly on the lifting mast 4 and/or through a passage 18 through the carriage means 13, wherein the lifting mast 4, in particular the thrust mast, has a cross-sectional shape 19 in the sense of a C- and/or H-profile 20 and that the displaceable roller unit 11 is guided by way of example on inner legs 21 of the C- and/or H-profile 20

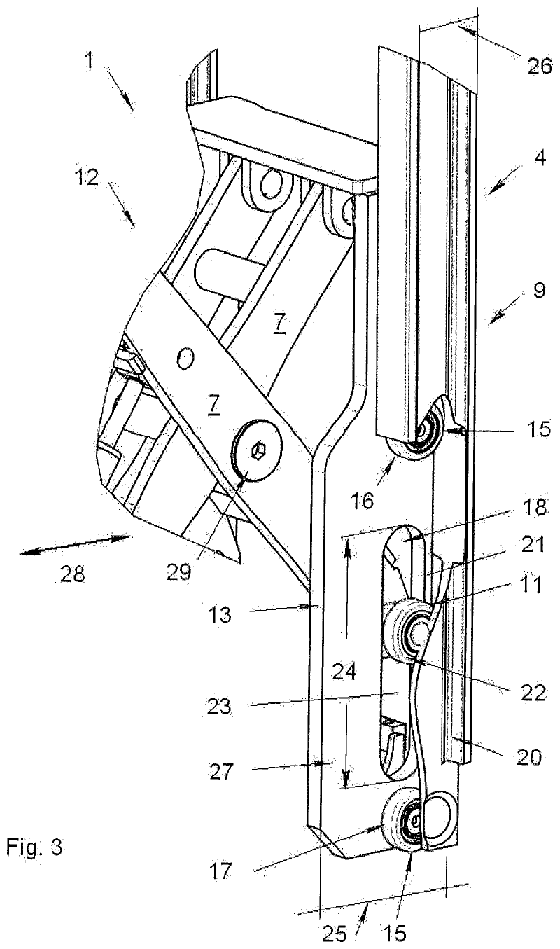

FIG. 3 shows a device 1 in a detail representation, wherein especially for example a feed-through 18 is made in form of an elongated hole 23, which allows a feed-through of a roller unit 22 which is lifting vehicle facing and movable. The exemplary height 24 of the elongated hole 23 corresponds to a total transversing 25 of the lever arm swings 7 of the scissor lever device 6, wherein a width 25 of the carriage means 13 is formed beyond a profile width 26 of the C and/or H profile 20 of the lifting mast 4, in particular in the region 27 of the feed-through 18, in particular of an elongated hole 23.

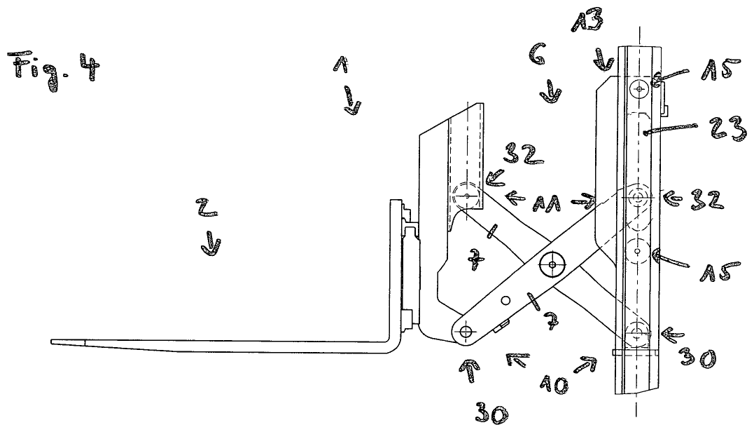

FIG. 4 shows a device 1 in a side view, wherein fixed support units 30 are arranged in a lower region, in particular below the guide rollers 15 of the carriage means 13, and displaceable support units 32 vertically substantially above the lever arm swings 7 by means of the device. By the device the load torques on the carriage means 13 are reduced. This also results in lower resultant support forces which act on the lifting mast and the carriage roller units, in particular guide rollers 15 of the carriage means 13.

### LIST OF REFERENCE SIGNS

1 device for moving

2 fork carrier

3 lifting vehicle

4 lifting mast

5 forklift

6 scissor lever device

7 lever arm swings

8 support region facing the fork carrier

9 support region facing the lifting vehicle

10 fixed roller unit

11 movable roller unit

12 attachment unit

13 carriage

15 guide roller

16 upper guide roller

17 lower guide roller

18 feed-through

19 cross-sectional shape

20 profile

21 leg

22 movable roller unit

23 elongated hole

24 height

25 width

26 profile width

27 region

28 total traversing

29 bearing point

30 fixed support unit

31 axis

32 displaceable support unit

1.-10. (canceled)

11. A device (1) for moving a fork carrier (2) of a lifting vehicle (3) with a lifting mast (4), comprising:
an attachment unit (12) arranged on the lifting mast (4) with
a scissor lever device (6) having at least two oppositely rotatably mounted lever arm swings (7), which are rotatably contacted at at least one bearing point (29) and which hold the fork carrier (2) movable substantially normally with respect to an axis (31) of the lifting mast (4),
wherein the lever arm swings (7) in a support region (8) facing the fork carrier and a further support region (9) facing the lifting vehicle (9) each have at least one fixed support unit (30), and
a support unit (32), which can be moved when the scissor lever device (6) is extended,
wherein at least one of the support units (32) is arranged to be slidably supported in an integrated manner in the further support region (9) facing the lifting vehicle, directly in contact with the lifting mast (4), so that a direct force input into the lifting mast (4) is established.

12. The device according to claim 11,
wherein the lifting vehicle (3) is a forklift,
wherein each at least one fixed support unit (30) is a roller unit (10), and
wherein each support unit (32) is a further roller unit (11).

13. The device according to claim 11,
wherein the attachment unit (12) at the support region (9) facing the lifting vehicle of the scissor lever device (6) has a carriage (13) for moving the attachment unit (12) along the lifting mast (4) facing the lifting vehicle.

14. The device according to claim 13,
wherein the carriage (13) comprises an upper guide roller (16) and a lower guide roller (17) which enable the attachment unit (12) to be moved along the lifting mast (4),
wherein the fixed support unit (30) of the lever arm swings (7) is a roller unit (10) that is fixed at a traversing of the scissor lever device (6) and is connected to the carriage (13), and
wherein the support unit (32) is a further roller unit (22) facing the lifting vehicle, is designed to be slidable past the carriage (13) and/or through a feed-through (18) through the carriage (13) directly on the lifting mast (4).

15. The device according to claim 14,
wherein the lifting mast has a cross-sectional shape (19) in form of a C- or H-shaped profile (20), and
wherein the support unit (32) is guided on legs (21) of the C- or H-shaped profile (20).

16. The device according to claim 15,
wherein the upper guide roller (16) and the lower guide roller (17) are guided on inner legs (21) of the C- or H-shaped profile (20) of the lifting mast (4), and the further roller unit (22) is designed to slide past the carriage (13) and/or is designed to be slidable through a passage (18) through the carriage (13) directly on the lifting mast (4).

17. The device according to claim 16,
wherein the passage (18) an elongated hole (23), which enables a feed-through of the support unit (32) facing the lifting vehicle.

18. The device according to claim 17,
wherein a height (24) of the elongated hole (23) is designed corresponding to at least a fraction of a total traversing (28) of the lever arm swings (7) of the scissor lever device (6) when the lever arm swings (7) are designed with a bearing point (29).

19. The device according to claim 17,
wherein a width (25) of the carriage (13) is formed beyond a profile width (26) of the C- or H-shaped profile (20) of the lifting mast (4) in a region (27) of the elongated hole (23).
